(19) United States
(12) Patent Application Publication
(10) Pub. No.: US 2006/0269128 A1
(43) Pub. Date: Nov. 30, 2006

(54) Image correction method and apparatus

(75) Inventor: Terekhov Vladislav, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/439,197

(22) Filed: May 24, 2006

(30) Foreign Application Priority Data
May 24, 2005 (KR) 2005-43769

(51) Int. Cl. G06K 9/00; G06K 9/40

(52) U.S. Cl. 382/167; 382/275

(57) ABSTRACT

An image correction method and apparatus are provided. The image correction apparatus includes an identification unit identifying a portion of an eye region where color is altered from an image; a verification unit extracting attribute information from the identified eye region and verifying the identified eye region; a determination unit determining whether pupils in the verified eye region are dilated; and a color correction unit correcting a color of the verified eye region according to whether the pupils are dilated. When the image correction method and apparatus are used, an eye region having a red-eye effect or highlighted due to the flash reflected off the cornea can be accurately identified, and the color of the identified eye region can be corrected.

### BACKGROUND OF THE INVENTION

This application claims the benefit under 35 U.S.C. §119(a) of Korean Patent Application No. 10-2005-0043769, filed on May 24, 2005, in the Korean Intellectual Property Office, the entire disclosure of which is hereby incorporated by reference.

1. Field of the Invention

The present invention relates to image correction. More particularly, the present invention relates to an image correction method and apparatus for identifying and verifying a portion of the eyes where color is altered due to a flash from a digital image which includes an image of a person, and correcting the color of the portion.

2. Description of the Related Art

When taking a picture of a subject using a flash, the subject's eyes in the resulting picture may display a red-eye effect or a highlight due to light from the flash reflected off the retina.

The red-eye effect occurs when a picture of a person is taken in a dark environment using a flash. The light of the flash results in a red appearance of the pupils in the picture. Generally, the pupils of a person contract in a bright environment to receive less light and dilate in a dark environment to receive more light. The pupils automatically adjust an amount of light that reaches the retina according to brightness.

When a person is photographed using a flash in a dark environment, a large amount of the light from the flash reaches the retina and is reflected by capillaries in the retina since the pupils of the person are already accustomed to darkness and dilated. The reflected light exits the eyes and the eyes of the person appear red in the photograph since the capillaries in the retina are also photographed. This occurs when a person is photographed using a flash in a dark environment, not a bright environment. A more noticeable red-eye effect occurs when there is a shorter distance between a flash and a camera lens and a greater distance between a person photographed and a camera.

A highlight occurs when light reflected off the cornea appears to change the color of the pupils and the iris. Conventional image correction methods and apparatuses will now be described.

In “Automated Detection and Correction of Color Defects due to Flash Illumination” disclosed in U.S. Pat. No. 5,432,863, pixels of each pupil are divided into three pixel categories using a YCC color system: body pixels, border pixels, and glint pixels as illustrated in FIG. 1. In this disclosure, YCC values of body pixels are set to Ynew=Yold*0.35, C1new=0, and C2new=0 to reduce the saturation of the body pixels. To reduce the saturation of border pixels, the YCC values of the border pixels are set to Ynew=Yold*0.15, C1new=C1old, and C2new=C2old. Additionally, the YCC values of glint pixels are set to Ynew=Yold, C1new=0, and C2new=0 to reduce the saturation of the glint pixels.

In “Apparatus and a Method for Reducing the Red-Eye in a Digital Image” disclosed in U.S. Pat. No. 6,016,354, the saturation of red pixels is reduced using a YCbBr color system. That is, YCC values are set to Ynew=Yold*0.8, Cbnew=0, and Cmew=0 to reduce the saturation of the red pixels. The shape of the eyes is corrected using a threshold value of a Cr color channel.

In “Image Processing to Remove Red-Eyed Features” disclosed in U.S. Patent No. 2004-0046878, the saturation of red pixels is reduced using an HLS color system. That is, HLS values (?) are set to Snew=0 and Lnew=o to reduce the saturation of the red pixels. The shape of the eyes is identified using information regarding the size of a highlighted portion.

“Red-Eye Filter Method and Apparatus” disclosed in U.S. Pat. No. 6,407,777 are used to analyze pixel information of the area around the eyes indicating an eye area. In addition, portions of the eyes highlighted by light reflected off the cornea, iris rings, and eyebrows are analyzed. Based on the analysis result, a determination of whether the red-eye area has been accurately identified is made.

In the case of the related art disclosed in U.S. Pat. No. 5,432,863, the corrected color of the pupils is unnatural. In the case of the related art disclosed in U.S. Pat. No. 6,016,354, a probability exists that the outline of the eyes is not accurately identified. In the case of the prior art disclosed in U.S. Patent No. 2004-0046878, the shape of the eyes may be inaccurately identified from an image due to a red portion not included in a portion of the eyes to be corrected.

The related art disclosed in U.S. Pat. No. 6,407,777, teaches eyes with dilated pupils which are often hard to identify since an iris ring becomes thin. Additionally, the color and position of the eyebrows make it difficult to accurately identify and analyze the eyes. Although the highlighted portion is regarded as white due to the light reflected off the cornea, the highlighted portion is a three-dimensional complex region.

Accordingly, there is a need for an improved system and method for identifying and verifying a portion of the eyes where color is altered due to a flash from a digital image and correcting the color of the portion.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention provides an image correction method and apparatus for identifying and verifying a portion of the eyes where color is altered due to a flash from a digital image and correcting the color of the portion. The digital image includes an image of a person.

According to an aspect of an exemplary embodiment of the present invention, an image correction apparatus is provided. An identification unit identifies a portion of an eye region where color is altered in an image. A verification unit extracts attribute information from the identified eye region and verifies the identified eye region. A determination unit determines whether pupils in the verified eye region are dilated and a color correction unit corrects a color of the verified eye region according to whether the pupils are dilated.

The eye region identified by the identification unit may include pixel information of a pupil portion having a red-eye effect, a sclera portion, a highlighted portion due to a flash reflected off the cornea, an outline portion, and an iris portion.

The verification unit may include an extraction unit to extract the attribute information from the identified eye region and an identification verification unit to verify the identified eye region based on the extracted attribute information.

The extraction unit may include a state determination unit to determine a state of eyes in the identified eye region and a pupil information deduction unit to derive diameters or centers of first and second pupils of the eyes according to the determined state of the eyes.

The state determination unit may include a gap calculation unit to calculate vertical and horizontal lengths of the eyes based on pixel information of the eye region and a state classification unit to compare the vertical and horizontal lengths of the eyes and to classify the state of the eyes as fully open or partially open.

The pupil information deduction unit may deduce the diameters or centers of the first and second pupils based on pixel information of the sclera portion and the pupil portion if the state of the eyes is classified as fully open.

The pupil information deduction unit may deduce the diameters or centers of the first and second pupils based on the pixel information of the outline portion and the pupil portion if the state of the eyes is classified as partially open.

The identification verification unit may include a lip center deduction unit to identify a lip region from the image and to derive a center of the lips. The identification verification unit may also include a generation unit to create a triangle by connecting the center of the lips and the centers of the first and second pupils and a first identification verification unit to compare lengths of sides of the created triangle and to verify the identified eye region.

The identification verification unit may identify a direction of a head portion or whether an eye in the identified eye region is a left eye or a right eye.

The identification verification unit may include a second identification verification unit to identify first and second outer corners of the eyes in the outline portion. The identification verification unit also compares a distance between the first outer corner and the center of the first pupil with a distance between the second outer corner and the center of the second pupil and verifies the identified eye region.

The determination unit may determine whether the pupils are dilated by comparing the horizontal lengths of the eyes with the diameters of the first and second pupils.

The color correction unit may include an iris color reading unit to read color information of the iris portion if a determination is made that the pupils are not dilated and a first correction unit to correct a color of a boundary of the iris portion connected to the pupil portion based on the read color information.

The first correction unit may correct the color of the iris portion using
R_{new}=Rᵢᵣᵢₛ+Rand, (1)
where R_{new} denotes a corrected color value of R, Rᵢᵣᵢₛ denotes a mean value of R in the iris, and RAND is a random number;
G_{new}=Gᵢᵣᵢₛ+Rand, (2)
where G_{new} denotes a corrected color value of G, Gᵢᵣᵢₛ denotes a mean value of G in the iris, and RAND is a random number; and
B_{new}=Bᵢᵣᵢₛ+Rand, (3)
where B_{new} denotes a corrected color value of B, Bᵢᵣᵢₛ denotes a mean value of B in the iris, and RAND is a random number.

The color correction unit may also include a second correction unit to correct the color of the highlighted portion due to the flash reflected from the cornea or the color of the pupil portion using
R_{new}=G_{new}=B_{new}=min(R_{old},G_{old},B_{old}), (4)
where R_{new} denotes a corrected color value of R, G_{new} denotes a corrected color value of G, B_{new} denotes a corrected color value of B, R_{old} is a current color value of R, G_{old} is a current color value of G, and B_{old} is a current color value of B.

According to another aspect of an exemplary embodiment of the present invention, an image correction method is provided. A portion of an eye region with altered color from an image is identified. Attribute information from the identified eye region is extracted and the identified eye region is verified. A determination is made as to whether pupils in the verified eye region are dilated and a color of the verified eye region is corrected according to pupils' dilation.

The identified eye region with the altered color may include pixel information of a pupil portion having a red-eye effect, a sclera portion, a highlighted portion due to a flash reflected off the cornea, an outline portion, and an iris portion.

The extraction of the attribute information and verification of the identified eye region may include extraction of the attribute information from the identified eye region and verification of the identified eye region based on the extracted attribute information.

The extraction of the attribute information may also include a determination of a state of eyes in the identified eye region and a derivation of diameters or centers of first and second pupils according to the determined state of the eyes.

The determination of the state of the eyes may include a calculation of vertical and horizontal lengths of the eyes based on pixel information of the eye region, a comparison between the vertical and horizontal lengths of the eyes, and a classification of the state of the eyes as fully open or partially open.

The diameters or centers of the first and second pupils may be deduced from the pixel information of the sclera portion and the pupil portion if the state of the eyes is classified as fully open.

The diameters or centers of the first and second pupils may also be deduced from pixel information of the outline portion and the pupil portion if the state of the eyes is classified as partially open.

The verification of the identified eye region identifies a lip region from the image, deduces a center of the lips, creates a triangle by connecting the center of the lips and centers of the first and second pupils, compares lengths of sides of the created triangle, and verifies the identified eye region.

The verification of the identified eye region identifies a direction of a head portion or whether an eye in the identified eye region is a left eye or a right eye.

The verification of the identified eye region may also include identification of first and second outer corners of the eyes in the outline portion, comparison of a distance between the first outer corner and the center of the first pupil with a distance between the second outer corner and the center of the second pupil, and verification of the identified eye region.

The determination of whether the pupils in the verified eye region are dilated may include a comparison of the horizontal lengths of the eyes with the diameters of the first and second pupils.

The correction of the color of the verified eye region may include: reading color information of the iris portion if a determination that the pupils are not dilated has been made; and correcting a color of the iris portion connected to the pupil portion based on the read color information.

In the correction of the color of the iris portion, the color of the iris portion may be corrected using
R_{new}=Rᵢᵣᵢₛ+Rand, (5)
where R_{new} denotes a corrected color value of R, Rᵢᵣᵢₛ denotes a mean value of R in the iris, and RAND is a random number;
G_{new}=Gᵢᵣᵢₛ+Rand, (6)
where G_{new} denotes a corrected color value of G, Gᵢᵣᵢₛ denotes a mean value of G in the iris, and RAND is a random number; and
B_{new}=Bᵢᵣᵢₛ+Rand, (7)
where B_{new} denotes a corrected color value of B, Bᵢᵣᵢₛ denotes a mean value of B in the iris, and RAND is a random number.

The correction of the color of the verified eye region may further include correcting the color of the highlighted portion due to the flash reflected from the cornea or the color of the pupil portion using
R_{new}=G_{new}=B_{new}=min(R_{old},G_{old},B_{old}) (8)
where R_{new} denotes a corrected color value of R, G_{new} denotes a corrected color value of G, B_{new} denotes a corrected color value of B, R_{old} is a current color value of R, G_{old} is a current color value of G, and B_{old} is a current color value of B.

According to another aspect of an exemplary embodiment of the present invention, a computer-readable recording medium is provided. A program for executing the method is recorded on the computer-readable recording medium.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates eye pixels grouped according to color in a conventional image correction method;

FIG. 2 is a block diagram of an image correction apparatus according to an exemplary embodiment of the present invention;

FIG. 3 is a flowchart illustrating an image correction method according to an exemplary embodiment of the present invention;

FIG. 4 is a flowchart illustrating operation 310 of FIG. 3;

FIG. 5 is a flowchart illustrating operation 320 of FIG. 3;

FIG. 6 is a flowchart illustrating operation 340 of FIG. 3;

FIGS. 7 through 13B are reference diagrams illustrating the image correction apparatus and method according to an exemplary embodiment of the present invention.

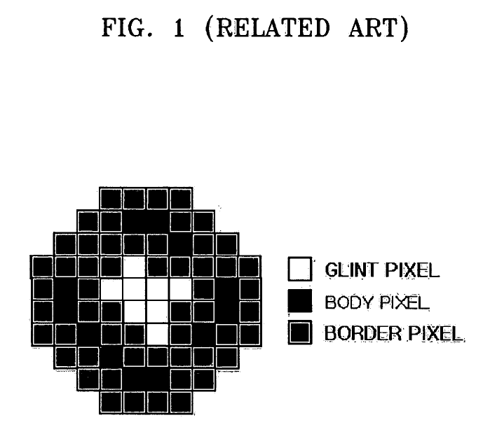

Throughout the drawings, the same drawing reference numerals will be understood to refer to the same elements, features, and structures.

### DETAILED DESCRIPTION OF THE INVENTION

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

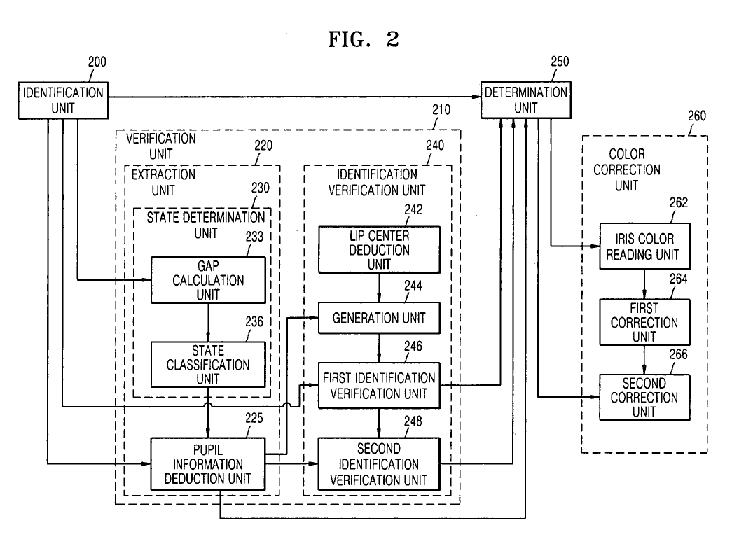

FIG. 2 is a block diagram of an image correction apparatus according to an exemplary embodiment of the present invention. The image correction apparatus includes an identification unit 200, a verification unit 210, a determination unit 250, and a color correction unit 260.

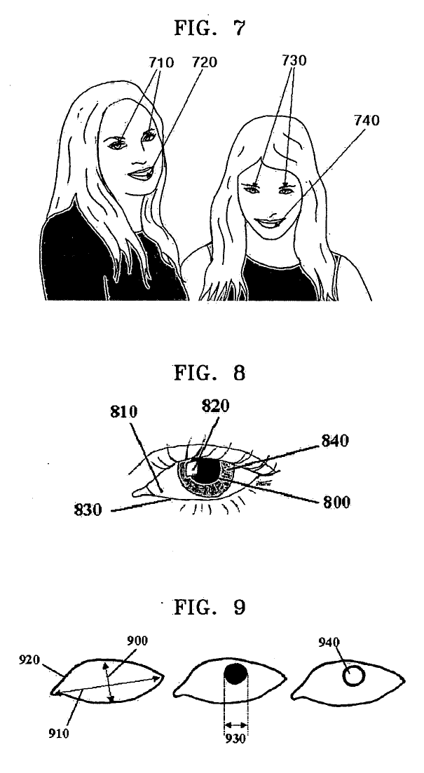

The identification unit 200 identifies a portion of an eye region with altered color in an image. The portion of the eye region with the altered color is a pupil portion having a red-eye effect caused by a flash, that is, a highlighted portion of the eyes resulting from the flash reflected off the retina. Referring to FIG. 8, the eye region identified by the identification unit 200 includes pixel information of a pupil portion 800 having the red-eye effect, a sclera portion 810, a highlighted portion 820 due to the flash reflected off the cornea, an outline portion 830, and an iris portion 840. For example, the identification unit 200 identifies eye regions 710 and 730 from an image shown in FIG. 7.

The verification unit 210 extracts attribute information from the eye region identified by the identification unit 200 and verifies the identified eye region. The verification unit 210 includes an extraction unit 230 and an identification verification unit 240.

The extraction unit 220 extracts attribute information from the eye region identified by the identification unit 200 and includes a state determination unit 230 and a pupil information deduction unit 240.

The state determination unit 230 determines the state of the eyes in the eye region identified by the identification unit 200. The state determination unit 230 includes a gap calculation unit 233 and a state classification unit 236.

The gap calculation unit 233 calculates eye parameters of the eye region identified by the identification unit 200. Referring to FIG. 9, the eye parameters include a visual field of the outline portion 920, a vertical length 900 of the eyes, and a horizontal length 910 of the eyes.

The state classification unit 236 classifies the state of the eyes as fully open and partially open based on the eye parameters calculated by the gap calculation unit 233. The state classification unit 236 compares the vertical length 900 of the eyes with the horizontal length 910 of the eyes. If the difference between the vertical length 900 and the horizontal length 910 exceeds a threshold value, the state classification unit 236 classifies the eye region (for example, the eyes) identified by the identification unit 200 as partially open. If the difference between the vertical length 900 and the horizontal length 910 does not exceed the threshold value, the state classification unit 236 classifies the eye region identified by the identification unit 200 as fully open.

The state classification unit 236 may classify the state of the eyes based on the visual field for the outline portion 920 of the eyes instead of the horizontal length 900 of the eyes. The state classification unit 236 classifies the state of the eyes as fully open and partially open because the sclera portion 810 is not prevalent when the eyes are partially open.

If the state classification unit 236 classifies the state of the eyes as fully open, the pupil information deduction unit 225 deduces a diameter 930 or a center 940 of first and second pupils based on pixel information of the sclera portion 810 and the pupil portion 800. On the other hand, if the state classification unit 236 classifies the state of the eyes as partially open, the pupil information deduction unit 225 deduces the diameter 930 or the center 940 of the first and second pupils based on pixel information of the outline portion 830 and the pupil portion 800. The pupil information deduction unit 225 deduces the diameter 930 or the center 940 of the first and second pupils from the shapes of the pupil portion 800, the sclera portion 810, and the outline portion 830. The shapes of the pupil portion 800, the sclera portion 810, and the outline portion 830 are inferred from the pixel information of the pupil portion 800, the sclera portion 810, and the outline portion 830 of the eyes.

The identification verification unit 240 verifies the eye region identified by the identification unit 200 based on the attribute information extracted by the extraction unit 220. The identification verification unit 240 includes a lip center deduction unit 242, a generation unit 244, a first identification verification unit 246, and a second identification verification unit 248.

The lip center deduction unit 242 identifies lip regions 720 and 740 from the image and deduces a center 1000 of the lips.

The generation unit 244 forms a triangle by connecting the center 1000 of the lips deduced by the lip center deduction unit 242, a center 1100 of the first pupil, and a center 1020 of the second pupil deduced by the pupil information deduction unit 225. For example, the generation unit 244 creates triangles by connecting the eye region 710 and the lip region 720, and the eye region 730 and the lip region 740, respectively as shown in FIG. 7.

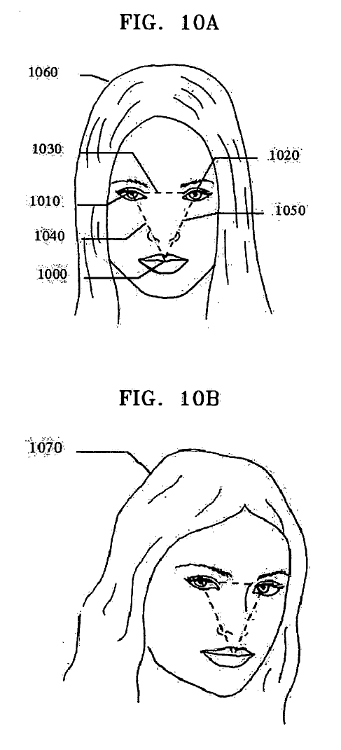

FIG. 10A illustrates a general digital image of a person. FIG. 10B illustrates a digital image of the person from a different angle. For example, FIG. 10B illustrates the digital image of the person facing forward even when seen from a different angle and a generated triangle. The triangle comprises a first side 1300 formed by connecting the center 1010 of the first pupil and the center 1020 of the second pupil, a second side 1040 formed by connecting the center 1000 of the lips and the center 1010 of the first pupil, and a third side 1050 formed by connecting the center 1000 of the lips and the center 1010 of the second pupil.

The first identification verification unit 246 compares the first side 1030 with the second side 1040 or the first side 1030 with the third side 1050 of the triangle created by the generation unit 244. The first identification verification unit 246 also verifies the eye region identified by the identification unit 200. If the ratio of the first side 1030 to the second side 1040 or the ratio of the first side 1030 to the third side 1050 does not exceed a threshold value, the first identification verification unit 246 determines that the eye region is inaccurately identified by the identification unit 200.

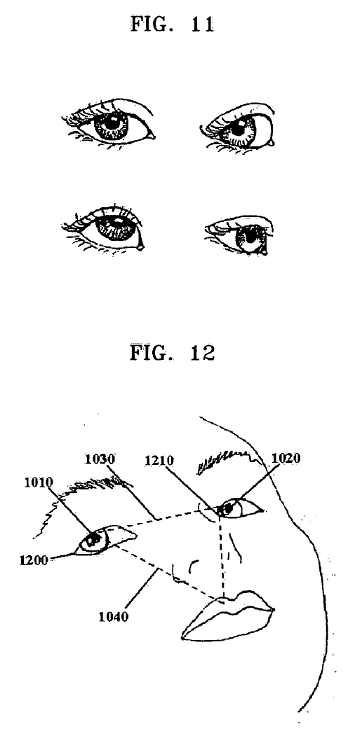

The identification verification unit 240 can estimate a direction and a position of a head, a position of an eyeball in the eye region, a direction in which the eye stares, and whether the eye is a left eye or a right eye based on the triangle created by the generation unit 244. FIG. 11 illustrates positions of an eye and directions in which the eye stares. For example, the identification verification unit 240 estimates that the head is outside of the triangle and perpendicular to the first side 1030 of the triangle.

The second identification verification unit 248 verifies the eye region using a method different from the method used in the first identification verification unit 246. Referring to FIG. 12, the second identification verification unit 248 identifies a first outer corner 1200 of the eyes and a second outer corner 1210 of the eyes from the outline portion 910 of the eyes. After the first and second outer corners 1200 and 1210 of the eyes are identified, the second identification verification unit 248 compares a distance between the first outer corner 1200 of the eyes and the center 1010 of the first pupil with the distance between the second outer corner 1210 of the eyes and the center 1020 of the second pupil. The second identification verification unit 248 verifies the eye region identified by the identification unit 200.

Since the pupils of the eyes move symmetrically, the relationship between the positions of the outer corners of the eyes and those of the pupils can be easily anticipated. If the distance between the center 1100 of the first pupil and the outer corner 1200 of the eyes and the distance between the center 1020 of the second pupil and the outer corner 1210 of the eyes exceed a threshold value, the second identification verification unit 248 determines that the eye region has been inaccurately identified by the identification unit 200.

If the first identification verification unit 246 or the second identification verification unit 248 verifies the eye region identified by the identification unit 200, the determination unit 250 compares the horizontal length 910 of the eyes with the diameter 930 of the pupils and determines whether the pupils are dilated.

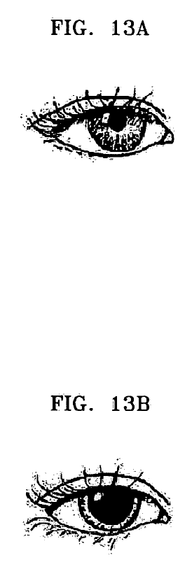

FIG. 13A illustrates a pupil that is not dilated. FIG. 13B illustrates a dilated pupil. If the ratio of the vertical length 910 of the eye to the diameter 930 of the pupil exceeds a threshold value, the determination unit 250 determines that the pupil in the eye region identified by the identification unit 200 has not been dilated as illustrated in FIG. 13A. If the ratio of the vertical length 910 of the eye to the diameter 930 of the pupil does not exceed the threshold value, the determination unit 250 determines that the pupil in the eye region identified by the identification unit 200 is dilated as illustrated in FIG. 13B.

The color correction unit 260 corrects the color of the eye region verified by the identification unit 200 according to the determination made by the determination unit 250 that the pupils are dilated.

The color correction unit 260 includes an iris color-reading unit 262, a first correction unit 264, and a second correction unit 266. If the determination unit 250 determines that the pupils in the eye region identified by the identification unit 200 have not been dilated, the iris color-reading unit 262 reads color information from the pixel information of the iris portion 840.

Based on the color information read by the iris color-reading unit 262, the first correction unit 264 corrects the color of a boundary portion of the iris portion 840 connected to the pupil portion 800 using
R_{new}=Rᵢᵣᵢₛ+Rand, (1)
where R_{new} denotes a corrected color value of R, Rᵢᵣᵢₛ denotes a mean value of R in the iris, and RAND is a random number;
G_{new}=Gᵢᵣᵢₛ+Rand, (2)
where G_{new} denotes a corrected color value of G, Gᵢᵣᵢₛ denotes a mean value of G in the iris, and RAND is a random number; and
B_{new}=Bᵢᵣᵢₛ+Rand, (3)
where B_{new} denotes a corrected color value of B, Bᵢᵣᵢₛ denotes a mean value of B in the iris, and RAND is a random number.

The second correction unit 266 corrects the color of the highlighted portion 820 due to the flash reflected off the cornea or the color of the pupil portion 800 using
R_{new}=G_{new}=B_{new}=min(R_{old},G_{old},B_{old}), (4)
where R_{new} denotes a corrected color value of R, G_{new} denotes a corrected color value of G, B_{new} denotes a corrected color value of B, R_{old} is a current color value of R, G_{old} is a current color value of G, and B_{old} is a current color value of B.

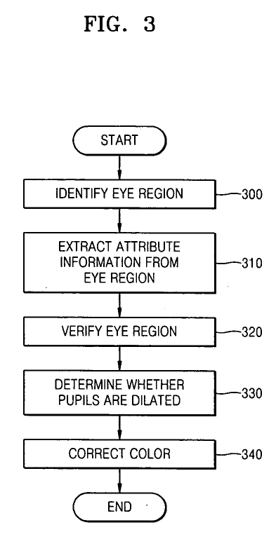

FIG. 3 is a flowchart illustrating an image correction method according to an exemplary embodiment of the present invention. Referring to FIG. 3, a portion of an eye region with altered color is identified from an image (operation 300). The eye region identified in operation 300 includes the pixel information of the pupil portion 800 having the red-eye effect, the sclera portion 810, the highlighted portion 820 due to the flash reflected off the cornea, the outline portion 830, and the iris portion 840. For example, the identification unit 200 identifies the eye regions 710 and 720 from the image shown in FIG. 7.

Attribute information is extracted from the eye region identified in operation 300 (operation 310). Based on the attribute information extracted in operation 310, the identified eye region is verified (operation 320).

A determination is made as to whether the pupil in the eye region verified in operation 320 is dilated (operation 330). In operation 330, the horizontal length 910 of the eyes is compared with the diameter 930 of the pupils to determine whether the pupils are dilated.

If the ratio of the vertical length 910 of the eyes to the diameter 930 of the pupils exceeds a threshold value in operation 330, a determination is made that the pupils are not dilated as illustrated in FIG. 13A. If the ratio of the vertical length 910 of the eyes to the diameter 930 of the pupils does not exceed the threshold value, a determination is made that the pupils are dilated as illustrated in FIG. 13B.

The color of the eye region identified in operation 300 is corrected according to a determination that the pupils are dilated in operation 330 (operation 340).

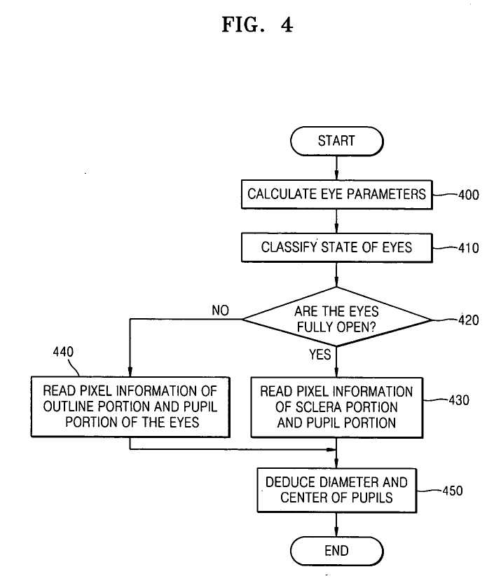

FIG. 4 is a flowchart illustrating operation 310 of FIG. 3. Referring to FIG. 4, eye parameters are calculated based on the pixel information of the eye region identified in operation 300 (operation 400). The eye parameters include the visual field for the outline portion 920, the vertical length 900, and the horizontal length 910 of the eyes.

The state of the eyes is classified as fully open and partially open based on the eye parameters calculated in operation 400 (operation 410). In operation 410, the vertical length 900 of the eyes is compared with the horizontal length 910 of the eyes. If the difference between the vertical length 900 and the horizontal length 910 exceeds a threshold value, the eyes in the eye region identified in operation 300 are classified as partially open. If the difference between the vertical length 900 and the horizontal length 910 does not exceed the threshold value, the eyes in the eye region identified in operation 300 are classified as fully open.

The state of the eyes may be classified based on the visual field for the outline portion 920 of the eyes instead of the horizontal length 900 of the eyes in operation 410. The state of the eyes is classified as fully open and partially open because the sclera portion 810 is not prevalent when the eyes are partially open.

If the state of the eyes is classified as fully open in operation 410, the pixel information of the sclera portion 810 and the pupil portion 800 is read (operation 430). If the state of the eyes is classified as partially open, the pixel information of the outline portion 830 and the pupil portion 800 is read (operation 440). The diameter 930 and the center 940 of the pupils are deduced from the pixel information read in operation 430 or 440 (operation 450).

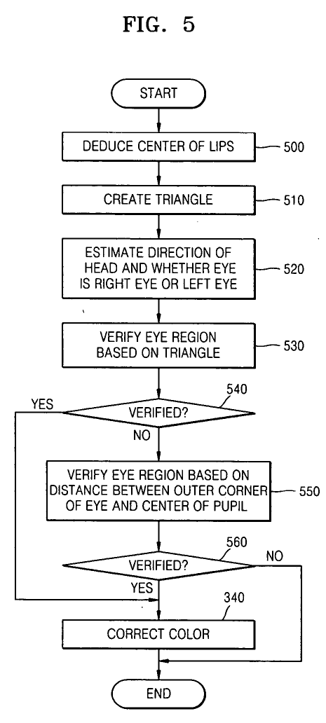

FIG. 5 is a flowchart illustrating operation 320 of FIG. 3. Referring to FIG. 5, the lip regions 720 and 740 are identified from the image and the center 1000 of the lips is deduced (operation 500).

A triangle is created by connecting the centers 940 of the pupils and the center 1000 of the lips deduced in operation 450. For example, in operation 510, triangles are created by connecting the eye regions 710 and the lip region 720, and connecting the eye regions 730 and the lip region 740.

The centers of the pupils deduced in operation 450 include the center 1010 of the first pupil and the center 1020 of the second pupil. The triangle created in operation 510 comprises the first side 1300, the second side 1040, and the third side 1050. The first side 1300 is formed by connecting the center 1010 of the first pupil and the center 1020 of the second pupil, the second side 1040 is formed by connecting the center 1000 of the lips and the center 1010 of the first pupil, and the third side 1050 is formed by connecting the center 1000 of the lips and the center 1010 of the second pupil.

The triangle created in operation 510 (520) determines the direction and the position of the head, the position of the eye in the eye region, the direction in which the eye stares, and whether the eye is a left eye or a right eye.

The eye region identified in operation 300 is verified (operation 530) based on the triangle created in operation 510. If the ratio of the first side 1030 to the second side 1040 or the ratio of the first side 1030 to the third side 1050 does not exceed a threshold value, a determination that the eye region has been inaccurately identified in operation 300 is made. Then, a determination is made as to whether the eye region identified in operation 300 has been verified (operation 540).

If a determination that the eye region has not been verified in operation 540 is made, the first outer corner 1200 of the eyes and the second outer corner 1210 of the eyes are identified from the pixel information of the outline portion 910 of the eyes. After the first and second outer corners 1200 and 1210 of the eyes are identified, the distance between the first outer corner 1200 of the eyes and the center 1010 of the first pupil is compared with the distance between the second outer corner 1210 of the eyes and the center 1020 of the second pupil. Then the eye region identified in operation 300 is verified (operation 550).

Since the pupils of the eyes move symmetrically, the relationship between the positions of the outer corners of the eyes and the positions of the pupils can be easily anticipated. In operation 550, if the distance between the center 1100 of the first pupil and the outer corner 1200 of the eyes and the distance between the center 1020 of the second pupil and the outer corner 1210 of the eyes exceeds a threshold value, a determination that the eye region has been inaccurately identified in operation 300 is made.

If a determination is made in operation 560 that the eye region has been inaccurately identified in operation 300, image correction is terminated. If a determination is made that the eye region has been accurately identified in operation 300, the color of the eye region identified in operation 300 is corrected (operation 340).

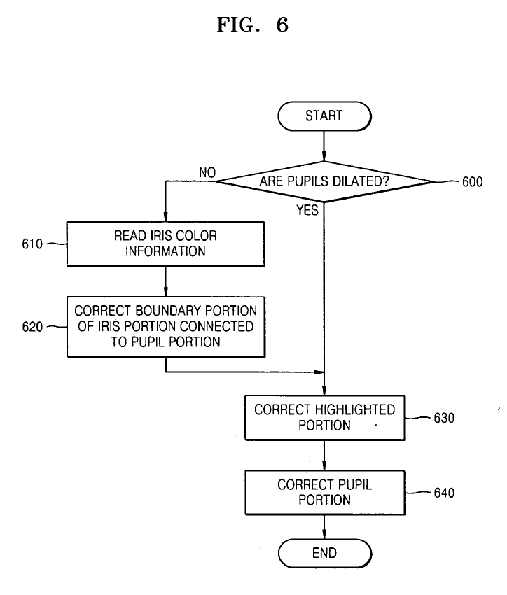

FIG. 6 is a flowchart illustrating operation 340 of FIG. 3. Referring to FIG. 3, a determination is made as to whether the pupil is dilated in operation 330 (operation 600). If a determination is made that the pupil is dilated in operation 600, color information is read from the pixel information of the iris portion 840 in the eye region identified in operation 300 (operation 610).

Based on the color information read in operation 610, the color of the boundary portion of the iris portion 840 connected to the pupil portion 800 is corrected using
R_{new}=Rᵢᵣᵢₛ+Rand, (5)
where R_{new} denotes a corrected color value of R, Rᵢᵣᵢₛ denotes a mean value of R in the iris, and RAND is a random number;
G_{new}=Gᵢᵣᵢₛ+Rand, (6)
where G_{new} denotes a corrected color value of G, Gᵢᵣᵢₛ denotes a mean value of G in the iris, and RAND is a random number; and
B_{new}=Bᵢᵣᵢₛ+Rand, (7)
where B_{new} denotes a corrected color value of B, Bᵢᵣᵢₛ denotes a mean value of B in the iris, and RAND is a random number.

After a determination has been made that the pupil is dilated in operation 600 or after operation 620, the color of the highlighted portion 820 due to the flash reflected off the cornea is corrected using the following equation (operation 630).
R_{new}=G_{new}=B_{new}=min(R_{old},G_{old},B_{old}) (8)
where R_{new} denotes a corrected color value of R, G_{new} denotes a corrected color value of G, B_{new} denotes a corrected color value of B, R_{old} is a current color value of R, G_{old} is a current color value of G, and B_{old} is a current color value of B.

After operation 630, the color of the pupil portion 800 is corrected using the process used in operation 630 (operation 640).

An exemplary embodiment of the present invention provides an image correction method and apparatus for identifying and verifying a portion of the eyes where color is altered due to a flash in a digital image which includes an image of a person, and correcting the color of the portion. Therefore, an eye region having a red-eye effect or highlighted due to the flash reflected off the cornea can be accurately identified, and the color of the identified eye region can be corrected to appear natural.

An exemplary embodiment of the present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices.

While the present invention has been shown and described with reference to certain exemplary embodiments thereof, it will be understood by those of ordinary skill in the art that various changes in form and details may be made therein without departing from the spirit and scope of the present invention as defined by the appended claims and their equivalents.

1. An image correction apparatus comprising:
an identification unit for identifying a portion of an eye region where color is altered in an image;
a verification unit for extracting attribute information from the identified eye region and verifying the identified eye region;
a determination unit for determining whether pupils in the verified eye region are dilated; and
a color correction unit for correcting a color of the verified eye region according to whether the pupils are dilated.

2. The apparatus of claim 1, wherein the eye region identified by the identification unit comprises pixel information of a pupil portion comprising at least one of a red-eye effect, a sclera portion, a highlighted portion due to a flash reflected off the cornea, an outline portion, and an iris portion.

3. The apparatus of claim 2, wherein the verification unit comprises:
an extraction unit for extracting the attribute information from the identified eye region; and
an identification verification unit for verifying the identified eye region based on the extracted attribute information.

4. The apparatus of claim 3, wherein the extraction unit comprises:
a state determination unit for determining a state of eyes in the identified eye region; and
a pupil information deduction unit for deriving at least one of diameters and centers of first and second pupils of the eyes according to the determined state of the eyes.

5. The apparatus of claim 4, wherein the state determination unit comprises:
a gap calculation unit for calculating vertical and horizontal lengths of the eyes based on pixel information of the eye region; and
a state classification unit for comparing the vertical and horizontal lengths of the eyes and classifying the state of the eyes as at least one of fully open and partially open.

6. The apparatus of claim 5, wherein the pupil information deduction unit deduces at least one of the diameters and centers of the first and second pupils based on pixel information of the sclera portion and the pupil portion if the state of the eyes is classified as fully open.

7. The apparatus of claim 5, wherein the pupil information deduction unit deduces at least one of the diameters and centers of the first and second pupils based on the pixel information of the outline portion and the pupil portion if the state of the eyes is classified as partially open.

8. The apparatus of claim 3, wherein the identification verification unit comprises:
a lip center deduction unit for identifying a lip region from the image and deriving a center of the lips;
a generation unit for creating a triangle by connecting the center of the lips and the centers of the first and second pupils; and
a first identification verification unit for comparing lengths of sides of the created triangle and verifying the identified eye region.

9. The apparatus of claim 8, wherein the identification verification unit identifies at least one of a direction of a head portion and determines whether an eye in the identified eye region comprises at least one of a left eye and a right eye.

10. The apparatus of claim 9, wherein the identification verification unit comprises a second identification verification unit identifying first and second outer corners of the eyes in the outline portion, comparing a distance between the first outer corner and the center of the first pupil with a distance between the second outer corner and the center of the second pupil, and verifying the identified eye region.

11. The apparatus of claim 5, wherein the determination unit determines whether the pupils are dilated by comparing the horizontal lengths of the eyes with the diameters of the first and second pupils.

12. The apparatus of claim 2, wherein the color correction unit comprises:
an iris color reading unit for reading color information of the iris portion if a determination is made that the pupils are not dilated; and
a first correction unit for correcting a color of a boundary of the iris portion connected to the pupil portion based on the read color information.

13. The apparatus of claim 12, wherein the first correction unit corrects the color of the iris portion using
R_{new}=Rᵢᵣᵢₛ+Rand,
where R_{new} denotes a corrected color value of R, Rᵢᵣᵢₛ denotes a mean value of R in the iris, and RAND comprises a random number;
G_{new}=Gᵢᵣᵢₛ+Rand,
where G_{new} denotes a corrected color value of G, Gᵢᵣᵢₛ denotes a mean value of G in the iris, and RAND comprises a random number; and
B_{new}=Bᵢᵣᵢₛ+Rand,
where B_{new} denotes a corrected color value of B, Bᵢᵣᵢₛ denotes a mean value of B in the iris, and RAND comprises a random number.

14. The apparatus of claim 2, wherein the color correction unit further
comprises a second correction unit correcting the color of the highlighted portion due to the flash reflected from at least one of the cornea and the color of the pupil portion using
R_{new}=G_{new}=B_{new}=min(R_{old},G_{old},B_{old}), (4)
where R_{new} denotes a corrected color value of R, G_{new} denotes a corrected color value of G, B_{new} denotes a corrected color value of B, R_{old} comprises a current color value of R, G_{old} comprises a current color value of G, and B_{old} comprises a current color value of B.

15. An image correction method comprising:
identifying a portion of an eye region with altered color from an image;
extracting attribute information from the identified eye region and verifying the identified eye region;
determining whether pupils in the verified eye region are dilated; and
correcting a color of the verified eye region according to whether the pupils are dilated.

16. The method of claim 15, wherein the eye region identified in the identifying of the portion of the eye region with the altered color comprises pixel information of a pupil portion comprising at least one of a red-eye effect, a sclera portion, a highlighted portion due to a flash reflected off the cornea, an outline portion, and an iris portion.

17. The method of claim 16, wherein the extraction of the attribute information and verification of the identified eye region comprises:
extracting the attribute information from the identified eye region; and
verifying the identified eye region based on the extracted attribute information.

18. The method of claim 17, wherein the extraction of the attribute information comprises:
determining a state of eyes in the identified eye region; and
deriving at least one of diameters and centers of first and second pupils according to the determined state of the eyes.

19. The method of claim 18, wherein the determination of the state of the eyes comprises:
calculating vertical and horizontal lengths of the eyes based on pixel information of the eye region; and
comparing the vertical and horizontal lengths of the eyes and classifying the state of the eyes as at least one of fully open and partially open.

20. The method of claim 19, wherein, in the deduction of at least one of the diameters and centers of the first and second pupils, at least one of the diameters and centers of the first and second pupils are deduced from the pixel information of the sclera portion and the pupil portion if the state of the eyes is classified as fully open.

21. The method of claim 19, wherein, in the deduction of at least one of the diameters and centers of the first and second pupils, at least one of the diameters and centers of the first and second pupils are deduced from pixel information of the outline portion and the pupil portion if the state of the eyes is classified as partially open.

22. The method of claim 17, wherein the verification of the identified eye region comprises:
identifying a lip region from the image and deducing a center of the lips;
creating a triangle by connecting the center of the lips and centers of the first and second pupils; and
comparing lengths of sides of the created triangle and verifying the identified eye region.

23. The method of claim 22, wherein, in the verification of the identified eye region, a direction of at least one of a head portion and a determination as to whether an eye in the identified eye region comprises at least one of an identified left eye and an identified right eye.

24. The method of claim 23, wherein the verification of the identified eye region comprises identifying first and second outer corners of the eyes in the outline portion, comparing a distance between the first outer corner and the center of the first pupil with a distance between the second outer corner and the center of the second pupil, and verifying the identified eye region.

25. The method of claim 15, wherein the determining of whether the pupils in the verified eye region are dilated comprises comparing the horizontal lengths of the eyes with the diameters of the first and second pupils.

26. The method of claim 16, wherein the correction of the color of the verified eye region comprises:
reading color information of the iris portion if a determination is made that the pupils are not dilated; and
correcting a color of the iris portion connected to the pupil portion based on the read color information.

27. The method of claim 26, wherein, in the correction of the color of the iris portion, the color of the iris portion is corrected using
R_{new}=Rᵢᵣᵢₛ+Rand,
where R_{new} denotes a corrected color value of R, Rᵢᵣᵢₛ denotes a mean value of R in the iris, and RAND comprises a random number;
G_{new}=Gᵢᵣᵢₛ+Rand,
where G_{new} denotes a corrected color value of G, Gᵢᵣᵢₛ denotes a mean value of G in the iris, and RAND comprises a random number; and
B_{new}=Bᵢᵣᵢₛ+Rand,
where B_{new} denotes a corrected color value of B, Bᵢᵣᵢₛ denotes a mean value of B in the iris, and RAND comprises a random number.

28. The method of claim 15, wherein the correction of the color of the verified eye region further comprises correcting the color of the highlighted portion due to the flash reflected from at least one of the cornea and the color of the pupil portion using
R_{new}=G_{new}=B_{new}=min(R_{old},G_{old},B_{old}) (8)
where R_{new} denotes a corrected color value of R, G_{new} denotes a corrected color value of G, B_{new} denotes a corrected color value of B, R_{old} comprises a current color value of R, G_{old} comprises a current color value of G, and B_{old} comprises a current color value of B.

29. A computer-readable recording medium on which a program for executing the method of claim 15 is recorded.

30. The apparatus of claim 12, wherein the color correction unit further
comprises a second correction unit correcting the color of the highlighted portion due to the flash reflected from at least one of the cornea and the color of the pupil portion using
R_{new}=G_{new}=B_{new}=min(R_{old},G_{old},B_{old}), (4)
where R_{new} denotes a corrected color value of R, G_{new} denotes a corrected color value of G, B_{new} denotes a corrected color value of B, R_{old} comprises a current color value of R, G_{old} comprises a current color value of G, and B_{old} comprises a current color value of B.
